(19) United States
(12) Patent Application Publication
(10) Pub. No.: US 2024/0398154 A1
(43) Pub. Date: Dec. 5, 2024

(54) BEVERAGE OR FOODSTUFF PREPARATION SYSTEM

(71) Applicant: SOCIETE DES PRODUITS NESTLE S.A., Vevey (CH)

(72) Inventors: SZABOLCS BALASI, Pully (CH); BERTRAND GUYON, Pontarlier (FR); MATTHIAS PFISTER, Liebefeld (CH); CYRIL STOLLER, Gumligen (CH); STEPHAN WYDER, Boll (CH)

(21) Appl. No.: 18/694,302

(22) PCT Filed: Sep. 16, 2022
(86) PCT No.: PCT/EP2022/075721

§ 371 Date: Mar. 21, 2024

(30) Foreign Application Priority Data
Sep. 22, 2021 (EP) 21198214.5

(51) Int. Cl. A47J 31/44; A47J 31/52; G06K 7/10; G06K 7/14

(52) U.S. Cl. CPC A47J 31/4492; A47J 31/52; G06K 7/10871; G06K 7/1443; G06K 7/1456

(57) ABSTRACT

A system comprising a container for containing precursor material and a machine for preparing a beverage and/or foodstuff or a precursor thereof from said precursor material, the container including: a machine-readable code storing preparation information, wherein the code extends along a encoding line, and comprises a series of discrete positions that either comprise or do not comprise a unit to at least partially encode the preparation information, the machine including: a code reading system to obtain a digital image of the code and to fit a colour model to the digital image; a processing unit for processing the precursor material of the container, and; electrical circuitry to control the processing unit based on the preparation information read from the code and the code reading system, wherein the electrical circuitry is configured to: sum values of the colour model along the encoding line, including for the units of the code and the encoding line; determine an orientation of the code based on said sum, and; read the discrete positions based on the determined orientation of the code in said image.

### TECHNICAL FIELD

The present disclosure relates to electrically operated beverage or foodstuff preparation systems, with which a beverage or foodstuff is prepared from a pre-portioned capsule that comprise a code encoding preparation information.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. Processing of the capsule in this manner causes the at least partial extraction of the precursor material from the capsule as the beverage.

This configuration of beverage preparation machine has increased popularity due to 1) enhanced user convenience compared to a conventional beverage preparation machines (e.g. compared to a manually operated stove-top espresso maker) and 2) an enhanced beverage preparation process, wherein: preparation information encoded by a code on the capsule is read by the machine, and; the preparation information is used by the machine to optimise the preparation process in a manner specific to the capsule. In particular, the encoded preparation information may comprise operating parameters selected in the beverage preparation process, including: fluid temperature; fluid pressure; preparation duration; and fluid volume.

Various codes have been developed, an example of which is provided in EP 2594171 A1, in which a periphery of a flange of a capsule comprises a code arranged thereon. A drawback of such a code is that it requires a precise location on the capsule so that it can be read as the capsule is rotated relative a code reader. A further example code is provided in WO2017144575A1, a drawback is that to determine an orientation of the code, the code requires specific reference units that are arranged at a centre and/or an outer periphery of circular encoding lines, with centre points of said reference units being used to define an reference line which is used to identify an orientation of the code.

Therefore, in spite of the effort already invested in the development of said systems further improvements are desirable.

### SUMMARY

The present disclosure provides a system comprising a container for containing precursor material and a machine for preparing a beverage and/or foodstuff or a precursor thereof from the precursor material. In embodiments, the container includes: a machine-readable code storing preparation information. In embodiments the container contains the precursor material.

In embodiments, the code extends along a encoding line, and comprises a series of discrete positions that either comprise or do not comprise a unit to at least partially encode the preparation information.

In embodiments, the machine includes: a code reading system to obtain a digital image of the code (including the encoding line) and to fit a colour model to the digital image; a processing unit for processing the precursor material of the container, and; electrical circuitry to control the processing unit based on the preparation information read from the code and the code reading system.

In embodiments, the electrical circuitry is configured to: sum values of the colour model along the encoding line, including for the units of the code and the encoding line; determine an orientation of the code based on said sum, and; read the discrete positions based on the determined orientation of the code in said image.

By implementing the electrical circuitry to determine a positional arrangement (e.g. an angle of the encoding line in the digital image) of the encoding line by summing values (e.g. numerical values) of the colour model with which the digital image formulated, along the line and also for units forming the code, the encoding line may be precisely located using said sum compared to parallel non-encoding lines which may have a different sum.

Since the units of the code (when present at a discrete position) are arranged on the encoding line, said units also contribute to the sum of the values and therefore identification of the orientation of the code. Hence the code has high efficiency, unlike with separate units only for location. Where a unit is not present at a discrete position, the encoding line intersects the discrete position, hence the encoding line at an absence of a unit also contributes to the sum of the values and therefore identification of the orientation of the code.

Compared to prior art arrangements, including those disclosing in WO2017144575A1, the embodiment code may be more convenient since only values of the colour model require summing and comparing to a condition, whereas the reference prior art requires locating individual units that form a reference portion of the code, finding a centre point of said units, and fitting a virtual reference line thereto.

In embodiments, the discrete positions encode the preparation information with Golay encoding. With such encoding, to read the code, the electrical circuitry may require only the orientation of the encoding line, since Golay encoding does not require a locator or reference portion as a reserved sequence of bits to identify where repetitions of the code comprising a data portion begin and end.

As used herein the term “Golay” or “Golay encoding” may refer to a type of binary code, which may have a linear arrangement and with error correction. The Golay code may encode a predefined number of unique values. The Golay code may not comprise a locator or reference portion to locate a data portion, rather the unique values may be arranged as repetitions. The electrical circuitry may determine the preparation information based on a key value database paradigm, e.g. as a stored relationship of electrical memory, wherein the unique value is used as a key to look-up the preparation information.

As used herein the term “colour model” or “colour system” may refer to a mathematical model describing the way colours (including shades of grey and tones with a wavelength in the infra red and ultraviolet regions) can be represented as values. The values may be numerical. Examples of colour models include: greyscale; RGB, RYG, CMY colour models; other models with values assigned to tones with a wavelength in the infra red and/or ultraviolet region. A set of values may be referred to as colour space or space.

As used herein the term “based on sum” may refer to the calculation of the orientation of the code and/or the encoding line including a step of summing the values, e.g. by numerical addition. For example it may comprise determining if the sum or a value derived from the sum (e.g. an average or variance or other like quantity) has met one or more of the following conditions: has crossed a threshold; is the highest in the data set; is the lowest in the data set.

As used herein the term “along and encoding line” in respect of the values of the colour model may refer to the encoding line or an area of a line section that includes the encoding line being decomposed into regions, that extend in a longitudinal direction along the encoding line, including all (e.g. from start to end of the encoding line in the image) or a substantial portion of said line, e.g. at least 80% or 90%. The regions have a value of the colour model, which is summed.

As used herein the term “at least partially encode” may refer to the preparation information on the code either directly encoding a value of a parameter of the preparation information, e.g. the value may be any numerical amount between a maximum and a minimum, and/or it may refer to the preparation information on the code being encoded via an identifier associated with a parameter, which is looked-up on the an electronic memory of the machine to derive a value for said parameter.

As used herein the term “based on the determined location” may refer to the code being read using a calculated location of the reference line.

As used herein the term “digital image” may refer to a digital representation of a real life image (e.g. of the code arranged on the container). The digital image may be comprised of pixels, each with finite size and a position identified as a coordinate (e.g. as a centre point of a pixel) and values of a colour model and optional intensity. The digital image may be of fixed or vector or raster type.

In embodiments, the electrical circuitry is configured to assign the values of the colour model to regions, wherein a region comprises: an individual pixel of the digital image, or; a grouping of a plurality of pixels in the digital image. The regions may have a coordinate assigned thereto to designate their spatial position. By implementing regions that comprise a group of pixels (e.g. by downscaling) computational efficiency may be improved. Alternatively the size of the pixels may be provided at the desired resolution.

In embodiments, electrical circuitry is configured to sum said values of the colour model for a line section that comprise: a lateral dimension of one or more regions, and; a longitudinal dimension of one or more regions to correspond to a longitudinal length that includes an encoding area within which the code is arranged. By arranging a line section to extend an entire longitudinal dimension of the encoding area, the encoding area can be decomposed into a number of laterally adjacent line sections, with each having a summed value, that comprises said sum of the values of the regions that comprise the line section. In this manner, a digital image may be conveniently idealised by an array of summed values for each line section.

As used herein the term “encoding area” may refer to an area of the digital image that comprise the code. For example the code (include repetitions of the code) may be arranged on an encoding area comprising circular region of a circular closing member of a Nespresso® classic capsule. Said circular region may exclude an outer periphery where the closing member is connected to a flange portion.

In embodiments, a lateral dimension of the encoding line is less than a lateral dimension of the line section. By arranging a lateral dimension of the encoding line (e.g. when the encoding line is aligned to the longitudinal direction of the line section) to be less than a lateral dimension of the line section, the encoding line can fit entirely within the line section so that it can substantially influence the values of the regions and therefore influence the sum of said values. In an example a lateral dimension of the encoding line is less 20% or 10% of the lateral dimension of the line section.

In embodiments, the electrical circuitry is configured to determine said sum for each of a plurality of line sections adjoining each other in the lateral direction. By implementing the sum to be calculated for adjoining line section, the entire digital image or the encoding area can be processed and idealised by an array of summed values for each line section.

In embodiments, the electrical circuitry is configured to: determine said sum with the encoding line arranged at a plurality of different angles to the a reference axis, and; based on said sum determine an aligned orientation in which the encoding line is aligned to the reference axis.

By implementing the electrical circuit to determine said sum (e.g. for the line section) with the digital image arranged at a plurality of different angles (e.g. by incrementing the angle of the digital image to the longitudinal direction of the line section through a range, including as between 0-180 degrees in 3 or 5 degree increments) the digital image may be conveniently rotated until a condition based on a sum of the values is identified, in which the encoding line is identified as being aligned (including substantially aligned) to a longitudinal direction (in which it is aligned to the line section).

In embodiments, the orientation of the code is determined based on a variance of said sum of values. By implementing the electrical circuitry to determine an orientation of the encoding line of the code based on the variance of the summation of values (e.g. for the line section) the code and encoding line may be conveniently distinguished from other non-encoding lines (e.g. a line section that does not comprise the code or the encoding line) of the digital image.

For example, with the encoding line aligned to a longitudinal direction, when the code and encoding line are within the line section it has a substantially influence on the sum, the sum is therefore identifiable from a sum of a parallel line section that comprises a non-encoding line. In this way the variance of the sums is large and can be used to discriminate against the code and encoding line not aligned to the longitudinal direction.

As used herein the term “based on a variance” may refer to a variance being directly implemented or a value related to the variance, e.g. a standard deviation etc, being implemented.

In embodiments, a lateral dimension of the encoding line is selected to be less than 20% or 10% a lateral dimension of a unit of the code. By implementing the encoding line to be comparatively thin compared to a unit of the code, during the step of reading the discrete positions, a presence of an encoding line through the discrete position may not be interpreted as a unit being present but the encoding lines presence ensures optimal effect on the values when summing said values. Alternatively, the encoding line may not be formed through a discrete position when absent a unit.

In embodiments, the code is arranged with: a summation of said values of the colour model along the encoding line to be within a first value range, and adjacent non-encoding lines which are parallel to the encoding line to comprise a summation of values of the colour model to be within a second value range.

By implementing the sum of the values for a line section comprising the encoding line to be within a first range and the sum of the values for a parallel line section that does not comprise the encoding line to be within a second different range the encoding line and non-encoding lines may be conveniently discriminated.

This may be achieved by having the line sections that do not comprise the encoding line absent substantial prints or formations that produce a comparable value to that of the code and encoding line. For example, a distribution of advertising or other information in the encoding area may be controlled to ensure the code can be discriminated.

In embodiments, the code and encoding line are arranged to be one of diffusively reflective or specular reflective, with a surround formed as the other of the one of diffusively reflective or specular reflective. As used herein the term “surround” may refer to a non-encoding line, including an area that does not comprise an encoding line and a unit of the code, it may include an area of a discrete position of the code that does not include a unit.

In embodiments, the electrical circuitry configured to identify diffusively reflective and specular reflective regions as values of a colour tone. For example, diffusely reflective regions may be assigned a low value with a greyscale colour model and specular reflective regions may be assigned a high value with a greyscale colour model. Such an arrangement may be advantageous since a visibility of the code may be less apparent than compared to forming the code and encoding line by printing in colour.

In embodiments, the code is arranged on an exterior surface of the container. The exterior surface on which the code is arranged is formed of (e.g. it presents an surface comprising) a first colour range.

In embodiments, the code extends across the exterior surface along a linear encoding line, and comprises a series of discrete positions that either comprise or do not comprise a unit to at least partially encode the preparation information, the unit and encoding line formed of a second colour range.

In embodiments, a summation of colour tones along the linear encoding line is identifiable compared to that for an adjacent, parallel linear non-encoding line (or any other line) that extends across said exterior surface. In embodiments, the machine includes: a code reading system to read the code of the container; a processing unit for processing the precursor material of the container, and; electrical circuitry to control the processing unit based on the preparation information read from the code, and the code reading system is configured to determine a location of the code from an image of said exterior surface based on said summation of colour tones.

By implementing the code on an encoding line that is of a particular colour range compared to other parts of the image of the exterior surface (e.g. the non-encoding lines) a position of the code may be conveniently, e.g. with low processing overhead and/or high accuracy, determined based on a summation of numerical values of the colour tones.

As used herein the term “exterior surface” may refer to any surface of the container than can present an image for reading by the code reading system, it can include an exterior surface of a closing member, a storage portion or a flange portion that interconnects the closing member and storage portion. Examples of suitable closing members and substrates can be derived from the teachings disclosed herein and examples relating to the containers and/or closing members. Suitable constructional and/or operational details are for instance disclosed in EP2569230.

As used herein the term “first colour range” may refer to a specific range of colour tones, for example the range may comprise: comparatively dark colours, including black, dark blue, dark green, dark purple; or comparative light colours, including white, light red, yellow. The range may also be defined by a greyscale (either in actual shades of grey or colours of said range that are converted to greyscale), for example for an 8 or 16 bit greyscale the first 0-100 bits may comprise the first colour range (that is black-dark grey). In a similar manner a bit colour, including 8 or 16 bit, may be implemented.

The term “second colour range” is defined as for the first colour range but is distinct therefrom, for example: if the first colour range comprises the comparatively dark colours then the second colour range comprises the comparatively light colours; if the first colour range comprises bits 150-255 (that is white to light grey of an 8-bit greyscale, then the second colour range comprises bits 0-100 (that is black to dark grey).

As used herein the term “discrete position” may refer to a reserved and distinct position in a sequence of discrete positions, which can comprise a unit or not comprise a unit as a means to encode information, typically as a bit.

As used herein the term “summation of colour tones along the linear encoding line” may refer to the encoding line (or a representative segment encapsulating the encoding line) analysed as a series of elements, e.g. with a pixel or a combination of pixels defining an element, with a representative value of the colour tones of each element being determined. The representative value may be a sum of the value of each colour tone, or it may be an averaged value, i.e. the sum of the value of each colour tone divided by the number of elements sampled. In the example where the encoding line is formed of a second colour range comprising an 8-bit greyscale in the range of bits 0-100: the each element will be assigned a value of 0-100, which is summed over all elements and optionally divided by the number of elements.

As used herein the term “non-encoding line” may refer to any line that may extend parallel to the encoding line that does not comprise the encoding line or a unit forming the code. The non-encoding line is typically one or a plurality of lines that directly adjoins the code.

As used herein the term “identifiable compared to that for an adjacent parallel linear non-encoding line” may refer to the summed value as previously described being substantially different for the encoding line when compared to that of the non-encoding line, e.g. 8-bit greyscale example, there may be a difference of at least 50. The summed value may also be identifiable from any other parallel line in the image, e.g. a non-encoding or other in the same manner.

As used herein the term “to determine a location of the code from an image” may refer to the identification of a position or angular relationship of the encoding line on which the code is arranged with respect to the image of the code being processed.

In embodiments, the first colour range comprises one of a comparatively light colour and the second colour range comprise the other of a comparatively light colour or a comparatively dark colour. By implementing said ranges, portions that form the code may be conveniently identified from those regions that do not.

In embodiments, the determined location comprises determining a rotational orientation of the code by an angle that the encoding line is to a reference axis associated with the image. For example, an image of the code may be assigned an arbitrary 2-dimensional axis and it may be determined that the encoding line is at a particular angle to the X-axis.

In embodiments, the code reading system is configured to increment a rotation of said image through a predetermined range, and to select from said range a rotation wherein the encoding line is aligned to the reference axis to update the rotational orientation of the image. For example, a reference X-axis may remain in a fixed position and the image of the exterior surface may be gradually rotated in increments about a centre including by 2-5 degrees until it is determined that the encoding line is sufficiently aligned to the X-axis.

In embodiments, the code is read with said rotational orientation along the encoding line in a first direction, and if an error is determined, then the code is read along the encoding line in a second opposed direction. With such an arrangement a directional code may be conveniently read in the correct direction.

In embodiments, a line along the encoding line comprises a greater variance of the first colour range and the second colour range, due to said absence or presence of a unit of the code, than a line along said adjacent non-encoding line, and the code reading system is configured determine a location of the code from said image by identifying the encoding line based on the encoding line being formed of said greater variance. For example, the area comprising an encoding line and non-encoding line can be idealised as a segment (which is enlarged in thickness from that of an encoding line to include the unit width of the code). A segment can be decomposed in to elements. In the 8-bit greyscale example, a variance in the element colour tone values is determined for the segment. Since the encoding line includes a substantial amount of units of the code that comprise the second colour range or absent units that comprises the exterior surface and therefore the first colour range (the non-encoding line in some examples may only comprise the first colour range) a line with a higher variance identifies an encoding line.

As used herein the term “based on the variance” may refer to a numerical quantity that either is the variance or is related thereto, including the standard deviation.

In embodiments, the location of the code determined by the variance comprises a lateral offset from the reference axis.

In embodiments, a lateral thickness of the encoding line is selected to be comparatively narrow (e.g. less than 20 or 10%) compared to that of a unit of the code. In embodiments, the code reading system is configured to determine the variance of the encoding line in a lower resolution than when determining said colour tones. By determining the variance in a lower resolution mode, that is selected so that the comparatively thin encoding line does not effect the determination of the variance, the presence of the encoding line may not prevent a high variance for the code being determined for locating the code.

In embodiments, the code is arranged as a repeating unit, which repeats itself along the encoding line. For example, the encoding line may include 2-4 repetitions of the code, any of which can be read to extract the preparation information. Such an arrangement may be more reliable since repetitions may be checked against each other, or if one repetition is damaged then another may be used.

In embodiments, there are multiple encoding lines, each offset from and parallel to each other. By implementing multiple encoding lines, if one encoding line is damaged, then another encoding line may be used.

In embodiments, the determined location comprises locating an encoding line with the greatest length based on said variance. By identifying the longest encoding line, the greatest chance of reading the code successfully may be achieved since the longest encoding line contains the greatest number of code repetitions.

In embodiments, the discrete positions are arranged to directly adjoin each other. In embodiments, an end region of a unit that does not adjoin another unit is curved. It has been found that curving an outer region of a unit provides a more aesthetically pleasing object that looks less like a code.

In embodiments, the container comprises: a storage portion, and; a closing member, wherein the exterior surface comprising the code and encoding line is arranged on the closing member. The container may comprise an axis of rotational symmetry that extends through a centre of the closing member. In embodiments, the encoding line extends between edges of the closing member to bisect the closing member and the image is of the entire closing member. The image obtained of the closing member may be circular and the closing member may be circular.

In embodiments, the non-encoding line (which may be directly adjoining the encoding line or arranged separated therefrom) comprises only the first colour range. With such an arrangement the encoding line may be conveniently discriminated from the non-encoding line.

In embodiments, the non-encoding line (which may be directly adjoining the encoding line or arranged separated therefrom) comprises the first colour range and a portion of the second colour range, which may be formed by one or more of objects that are unrelated to the code. However, the proportion of the second colour range may be selected to be identifiable less (e.g. in terms of variance or tone summation) than that provided by the code and/or the encoding line. With such an arrangement, the encoding line may be conveniently discriminated from the non-encoding line during processing, and the non-encoding line can comprise other objects, including include a logo; a trademark; text; an image, which can provide one or more of the following or other effects: information about the container to a user, e.g. a blend of coffee; a more aesthetically pleasing exterior surface than that with only a code on it, and; alterative objects so that the user does not focus on the code.

In embodiments, the code reading system is configured to read the code based on the determine a location and to decode the read code with an algorithm, e.g. a Golay algorithm.

The present disclosure provides, a machine for preparing a beverage and/or foodstuff or a precursor thereof from a container comprising precursor material and a code, the machine including the features of the machine of the system of any of the preceding embodiments or another embodiment disclosed herein.

In embodiments, the processing unit includes a container processing unit and a fluid processing system, and; the electrical circuitry is arranged to control the container processing unit and fluid processing system based on the preparation information read from the code. In embodiments, the processing unit is arranged as a loose material processing unit, and; the electrical circuitry is arranged to control the loose material processing unit to process loose precursor material dispensed from the container or arranged in the container based on the preparation information read from the code.

The present disclosure provides a container for containing a precursor material for use with a machine for preparing a beverage or foodstuff or a precursor thereof. The machine may be according to any preceding embodiment or another embodiment disclosed herein.

In embodiments, the container includes a machine-readable code storing preparation information for processing precursor material. The code may comprise any feature of the preceding embodiments or another embodiment disclosed herein.

In embodiments, the code extends along a encoding line, and comprises a series of discrete positions that either comprise or do not comprise a unit to at least partially encode the preparation information.

In embodiments, a sum of values of colour model fitted to a digital image of the code along the encoding line is identifiable compared to that for an adjacent, parallel non-encoding line, for determination an orientation of the code based on said sum.

In embodiments, the container includes an exterior surface comprising a machine-readable code comprising any feature of the preceding embodiments or another embodiment disclosed herein. The code stores preparation information for use with a preparation process performed by said machine, in which the machine is controlled based on the preparation information to prepare the beverage and/or foodstuff or precursor thereof.

The present disclosure provides a substrate for attachment to a container for containing a precursor material for use with a machine for preparing a beverage and/or foodstuff or a precursor thereof, the substrate including an exterior surface comprising a machine-readable code comprising any feature of the preceding embodiments or another embodiment disclosed herein.

As used herein the term “substrate” may refer to any suitable carrier for the code that can be used to connect the code to a container, examples of which include: a sticker; a cardboard member to receive an adhesive strip; a closing member, and; other suitable arrangements.

The present disclosure provides use of the container of any preceding embodiment or another embodiment disclosed herein for a machine of any preceding embodiment or another embodiment disclosed herein.

The present disclosure provides a method of reading preparation information for processing precursor material, which is encoded by a code on a container comprising the precursor material.

The method may be implemented to read the code of any preceding embodiment or another embodiment disclosed herein.

In embodiments the method comprises: fitting a colour model to a digital image of the code; summing values of the colour model along a encoding line, including for units of the code and the encoding line; determining an orientation of the code based on said sum, and; reading discrete positions of the code, which comprise or do not comprise a unit to at least partially encode the preparation information, based on the determined orientation of the code in said image.

The present disclosure provides a method of reading a code on an exterior surface of a capsule, the method comprising: generating an image of the exterior surface of the capsule, which include the code, and; reading said code.

In embodiments, the method comprises obtaining, for lines (e.g. segments) extending across the image, a summation of colour tones and locating the code based on said summation of colour tones.

In embodiments, the method comprises obtaining, for lines (e.g. a segment) extending across the image, a variance (including a value related to the variance) of the first colour range and the second colour range, and; locating the code based on said variance of colour tones.

The method may be implemented as part of a method of preparing a beverage or foodstuff or a precursor thereof, in which a processing unit is controlled based on the preparation information to execute a preparation process on the precursor material.

The present disclosure provides electrical circuitry to implement the method of the preceding embodiment or another embodiment disclosed herein.

The present disclosure provides a computer readable medium comprising program code to implement the method of the preceding embodiment or another embodiment disclosed herein.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff or a precursor thereof.

FIG. 2 is a block system diagram showing an embodiment machine of the system of FIG. 1.

FIG. 3 is an illustrative diagram showing an embodiment fluid conditioning system of the machine of FIG. 2.

FIGS. 4A and 4B are illustrative diagrams showing an embodiment container processing system of the machine of FIG. 2.

FIG. 5 is an illustrative diagram showing an embodiment machine of FIG. 2, which comprises a loose material processing unit.

FIG. 6 is a block diagram showing embodiment control electrical circuitry of the machine of FIG. 2.

FIGS. 7 and 8 are illustrative diagrams showing embodiment containers of the system of FIG. 1.

FIG. 9 is flow diagram showing an embodiment preparation process, which is performed by the system of FIG. 1.

FIG. 10 is a view showing in image of a closing member of the container of FIG. 7 that comprise an exterior surface and a code and an encoding line.

FIG. 11 is a view showing a close-up of part of the image of FIG. 10 that comprises the code.

FIG. 12 is a view showing a close-up of part of the image of FIGS. 10 and 11 that comprises the code.

FIG. 13 is a view showing top and bottom images of FIG. 10 at two different rotational positions.

FIG. 14 is a contour plot showing an averaged colour tone for a segment for rotational position of the image vs. segment lateral position.

FIG. 15 is a graphical plot showing the segment lateral position vs. standard deviation for the bottom image of FIG. 13.

FIGS. 16 and 17 are flow diagrams showing an embodiment processes for locating and reading the code of FIG. 10, which is performed by the system of FIG. 1.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. The machine may implement said preparation by one or more of the following processes: dilution; heating; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a membrane for closing the container. The container may have various forms, including one or more of: frustoconical; cylindrical; disk; hemispherical; packet; other like form. The container may be formed from various materials, such as metal or plastic or a combination thereof. The material may be selected such that it is: food-safe; it can withstand the pressure and/or temperature of a preparation process. The container may be defined as a capsule, wherein a capsule may have an internal volume of 20-100 ml. The capsule includes a coffee capsule, e.g. a Nespresso® capsule (including a Classic, Professional, Vertuo, Dolce Gusto or other capsule). The container may be defined as a receptacle, wherein a receptacle may have an internal volume of 150-350 ml. The receptacle is typically for end user consumption therefrom, and includes a pot, for consumption via an implement including a spoon, and a cup for drinking from. The container may be defined as a packet, wherein the packet is formed from a flexible material, including plastic or foil. A packet may have an internal volume of 150-350 ml or 200-300 ml or 50-150 ml.

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two of more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid; a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder; powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to to change a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; fliting/purifying, and; other conditioning process.

As used herein, the term “processing unit” may refer to an arrangement that can process precursor material to a beverage or foodstuff. It may refer to an arrangement that can process a pre-precursor material to a precursor material. The processing unit may have any suitable implementation, including a container processing unit or a loose material processing unit.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore; a dispensing and dissolution unit (which extracts a portion of the precursor material from a repository, processes by dissolution and dispenses it into a receptacle), and: other like unit.

As used herein, the term “loose material processing unit” may refer to an arrangement that can process loose material of a pre-precursor material to a precursor material. The loose material processing unit may be arranged to process the pre-precursor material by one of more of the following: heating; cooling; grinding; mixing; soaking; conditioning; other processing step. The loose material may be supplied to the loose material processing unit in a container, from which it is extracted and processed.

As used herein, the term “preparation process” may refer to a process to prepare a beverage or foodstuff from a precursor material or to prepare a pre-precursor material from precursor material. A preparation process may refer to the processes electrical circuitry executes to control the container processing unit to process said precursor or pre-precursor material.

As used herein, the term “electrical circuitry” or “circuitry” or “control electrical circuitry” may refer to one or more hardware and/or software components, examples of which may include: an Application Specific Integrated Circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method, or each other.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); High-Definition Multimedia Interface (HDMI) or other protocol implementations. The machine may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet.

As used herein, the term “code” may refer to storage medium that encodes preparation information. The code may be an optically readable code, e.g. a bar code. The code may be formed of a plurality of units, which can be referred to as elements or markers.

As used herein, the term “preparation information” may refer to information related to a preparation process. Depending on the implementation of the processing unit said information may vary. The parameters that may be associated container processing unit that comprises a fluid processing system, can include one or more of: fluid pressure; fluid temperature; mass/volumetric flow rate; fluid volume; filtering/purification parameters for the fluid; carbonation parameters for the fluid. The parameters that may be associated container processing unit that comprises a loose material processing unit, can include one or more of: grinding parameters, including intensity; heating temperature. More general parameters can include one or more: container geometric parameters, e.g. shape or volume; the type of precursor; phase identifier, for when a preparation process is split into a series of phases, whereby each phase comprises a set of one or more of any of the aforesaid parameters; duration, including phase duration (e.g. a duration for applying the parameters of a phase or any of the aforementioned parameters generally; and a container identifier, which may for example be used to monitor container consumption for the purpose of container re-ordering or look-up of information from the server system; an expiry date, a recipe identifier, which may be used to lookup a recipe stored on the memory of the machine for use with the container.

### General System Description

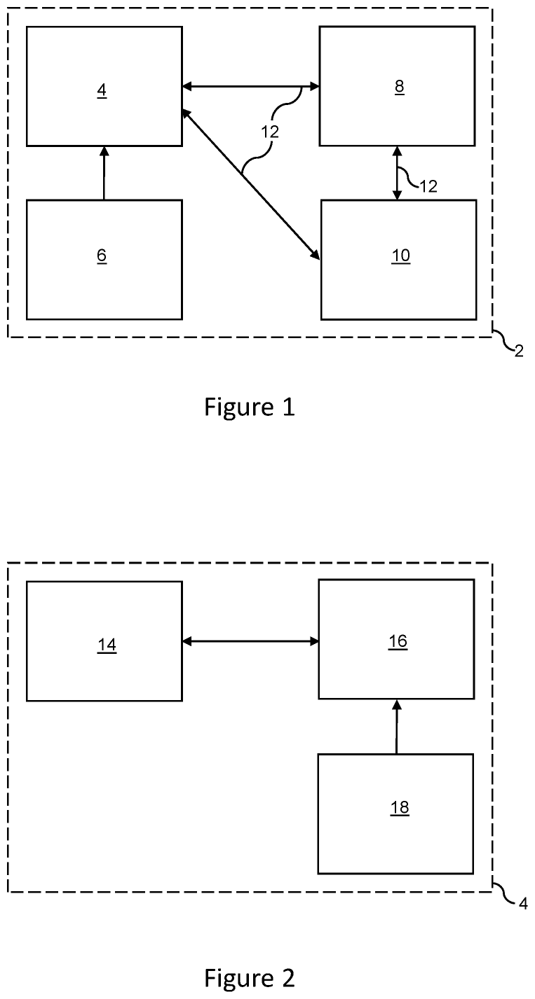

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a wireless interface, e.g. with a Bluetooth™ protocol, and; the server system communicates with the machine via a via a wireless interface, e.g. with a IEE 802.11 standard, and also via the internet.

### Machine

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

### First Example of Processing Unit

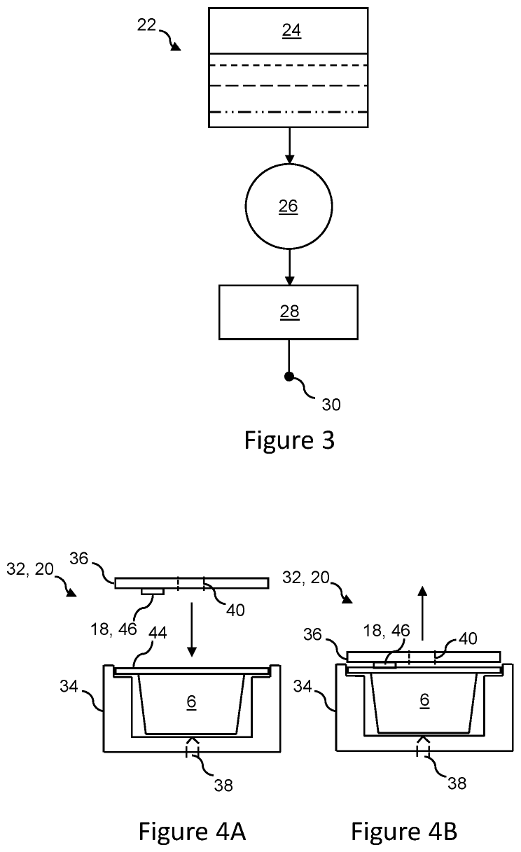

Referring to FIGS. 3 and 4, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

### Fluid Conditioning System

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 26 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump); the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### Container Processing Unit

The container processing unit 20 can be implemented with a range of configurations, as illustrated in examples 1-6 below:

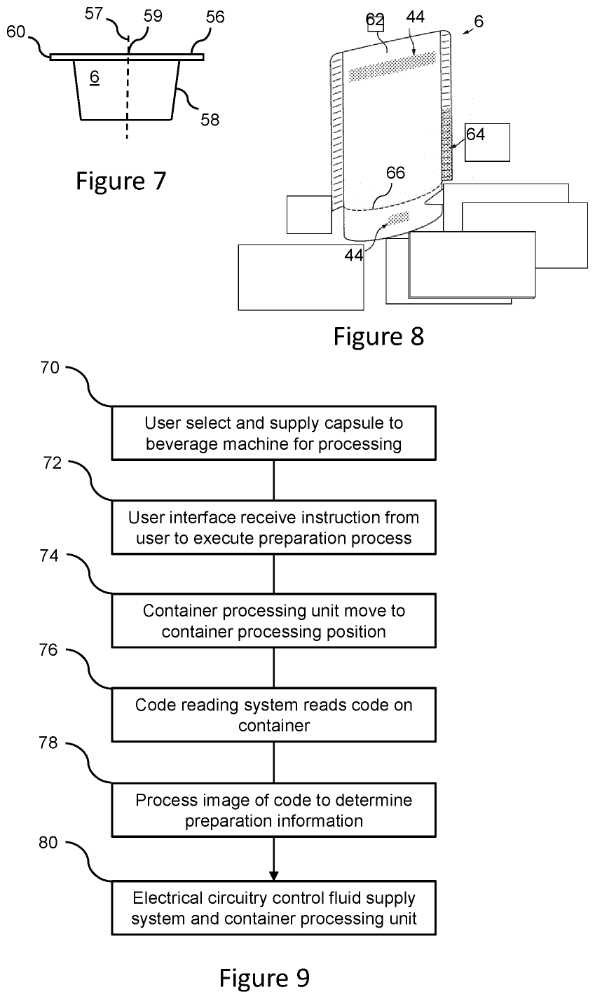

Referring to FIGS. 4A and 4B, a first example of the container processing unit 20 is for processing of a container arranged as a capsule 6 (a suitable example of a capsule is provided in FIG. 7, which will be discussed) to prepare a beverage. The container processing unit 20 is configured as an extraction unit 32 to extract the beverage from the capsule 6. The extraction unit 32 includes a capsule holding portion 34 and a closing member 36. The extraction unit 32 is movable to a capsule receiving position (FIG. 4A), in which capsule holding portion 34 and a closing member 36 are arrange to receive a capsule 6. The extraction unit 32 is movable to a capsule extraction position (FIG. 4B), in which the capsule holding portion 34 and a closing member 36 form a seal around a capsule 6, and the beverage can be extracted from the capsule 6. The extraction unit 32 can be actuator driven or manually movable between said positions.

The outlet 30 of the fluid conditioning system 22 is arranged as an injection head 38 to inject the conditioned fluid into the capsule 6 in the capsule extraction position, typically under high pressure. A beverage outlet 40 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C.) fluid to the precursor material within the capsule 6. The pressure is increased over a predetermined amount of time until a pressure of a rupturing portion, which is the closing member of the capsule 6 is exceeded, which causes rupture of said member and the beverage to be dispensed to the beverage outlet 40.

In variant embodiments, which are not illustrated, although the injection head and beverage outlet are illustrated as arranged respectively on the holding portion and capsule closing member, they may be alternatively arranged, including: the injection head and beverage outlet are arranged respectively on the capsule closing member and storing portion; or both on the same portion. Moreover, the extraction unit may include both parts arranged as a capsule holding portion, e.g. for capsules that are symmetrical about the flange, including a Nespresso® Professional capsule.

Examples of suitable extraction units are provided in EP 1472156 A1 and in EP 1784344 A1, which are incorporated herein by reference, and provide a hydraulically sealed extraction unit.

In a second example (which is not illustrated) of the container processing unit a similar extraction unit to the first example is provided, however the extraction unit operates at a lower pressure and by centrifugation. An example of a suitable capsule is a Nespresso® Vertuo capsule. A suitable example is provided in EP 2594171 A1, which is incorporated herein by reference.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a containment portion of the capsule. An example of a suitable capsule is a Nespresso® Dolce Gusto capsule. Examples of suitable extraction units are disclosed in EP 1472156 A1 and in EP 1784344 A1, which are incorporated herein by reference.

In a fourth example, (which is not illustrated) wherein the container is arranged as a packet, the container processing unit implements an extraction unit operable to receive the packet and to inject, at an inlet thereof, fluid from the fluid conditioning system. The injected fluid mixes with precursor material within the packet to at least partially prepare the beverage, which exits the packet via an outlet thereof. An example of such an arrangement is provided in WO2014125123 A1, which is incorporated herein by reference.

In a fifth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer; spiral mixer; vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1, which is incorporated herein by reference.

In a sixth example, (which is not illustrated) the container processing unit is arranged as a dispensing and dissolution unit. The dispensing and dissolution unit is arranged to extract a single serving portion of beverage or foodstuff precursor from a storage portion of the machine (which can include any multi-portioned container including a packet or box). The dispensing and dissolution unit is arranged to mix the extracted single serving portion with the conditioned fluid from the fluid conditioning system, and to dispense the beverage or foodstuff into a receptacle. An example of such an arrangement is provided in EP 14167344 A, which is incorporated herein by reference.

### Second Example of Processing Unit

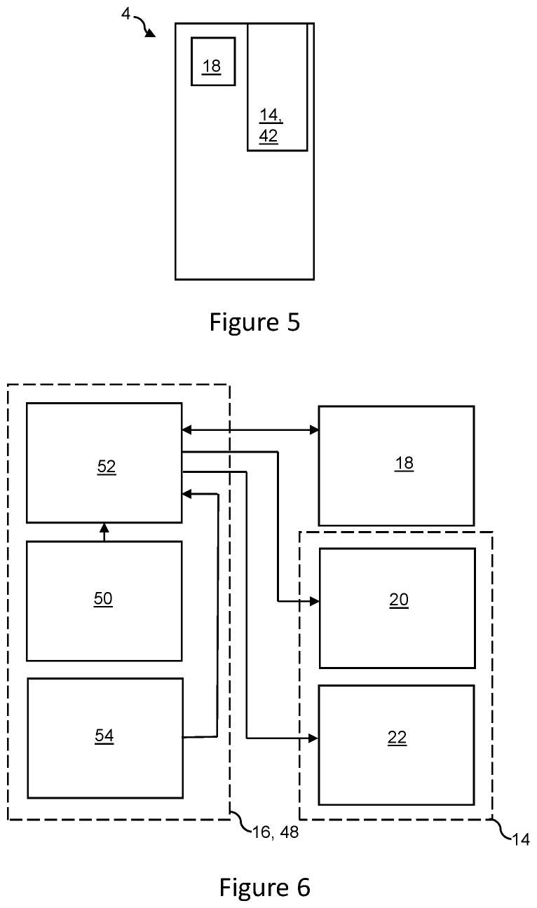

Referring to FIG. 5, in a second example of the processing unit 14, said unit comprises a comprises a loose material processing unit 42.

The loose material processing unit 42 is arranged to receive loose pre-precursor material from a container 6 (a suitable example is provided in FIG. 8 as will be discussed) and to process the pre-precursor material to derive the precursor material. The electrical circuitry 16 uses the preparation information read from the container 6 to control the loose material processing unit 42 to execute the preparation process.

A user resents manually the container 6 to a code reading system 18, of the machine 4, to read the code (as will be discussed). The user then opens the container 6 and dispenses the pre-precursor material (not illustrated) arranged therein into the loose material processing unit 42. The loose material processing unit 42 processes the loose pre-precursor material to the precursor material.

In a particular example, the pre-precursor material is coffee beans, and the loose material processing unit 42 is arranged to roast and/or grind the coffee beans to provide a precursor material.

In variant embodiments, which are not illustrated, the loose material processing unit is alternatively configured, including: with a dispensing system to open and dispense the pre-precursor from the capsule for subsequent processing (e.g. it may include a cutting tool to cut open the container and an extractor such as a scop to extract the pre-precursor material); the pre-precursor material may be processed in the container and either dispensed from the container by the aforedescribed example or provided to a user in the container.

### Code Reading System

Referring to FIGS. 4A and 4B, the code reading system 18 is arranged to read a code 44 arranged on a closing member of the container 6. The code reading system 18 is integrated with the extraction unit 32 of first example of the container processing unit 20. The code 44 is read with the extraction unit 32 in the capsule extraction position (as shown in FIG. 4B).

The code reading system 18 includes an image capturing unit 46 to capture a digital image of the code 44. Examples of a suitable image capturing unit 46 include a Sonix SN9S102; Snap Sensor S2 imager; an oversampled binary image sensor; other like system.

The electrical circuitry 18 includes image processing circuitry (not illustrated) to identify the code in the digital image and extract preparation information. An example of the image processing circuitry is a Texas Instruments TMS320C5517 processor running a code processing program.

In variant embodiments, which are not illustrated, the code reading system is separate from the container processing unit including: it is arranged in a channel that the user places the container in and that conveys the container to the container processing unit; it is arranged to read a code on a receptacle, which is positioned to receive a beverage from an beverage outlet of a dispensing and dissolution unit. In further variant embodiments, which are not illustrated, the code reading system is alternatively implemented, e.g. the code reading system is arranged on the machine to read a code of a container that a user manually presents to the image capturing device. In further variant embodiments, which are not illustrated, the code reading system is arranged to read a code at a different location of the container, e.g. on a flange portion or storage portion.

### Control Electrical Circuitry

Referring to FIG. 6, the electrical circuitry 16 is implemented as control electrical circuitry 48 to control the processing unit 14 to execute a preparation process. In the embodiment of FIG. 6, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 46 and to provide a control output to the processing unit 14, and; a feedback system 54 to provide feedback from the processing unit 54 during the preparation process, which may be used to control the preparation process.

The input unit 50 is implemented as a user interface, which can include one or more of: buttons, e.g. a joystick button or press button; joystick; LEDs; graphic or character LDCs; graphical screen with touch sensing and/or screen edge buttons; other like device; a sensor to determine whether a container has been supplied to the machine by a user.

The feedback system 54 can implement one or more of the following or other feedback control based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 48 is suitably adapted for the other examples of the processing unit 14, e.g.: for the second example of the container processing system the feedback system may be used to control speed of rotation of the capsule; for the loose material processing unit the feedback system may be used to implement control of grinding rate and/or a heating temperature.

### Container

Referring to FIG. 7, a first example of a container 6, that is for use with the first example of the processing unit 14 comprises the container 6 arranged as a capsule. The capsule includes: a closing member 56; a storage portion 58, and; a flange portion 60.

The storage portion 58 includes a cavity for storage of the precursor material (not illustrated). The closing member 56 closes the storage portion 58 and comprises a flexible membrane. The flange portion 60 is arranged at the junction of the storage portion 58 and closing member 56 and comprise an overlap of each portion that is fixed together to hermetically seal the precursor material. The capsule 6 has a diameter of 2-5 cm and an axial length of 2-4 cm. Referring to FIG. 4A and 4B, the storage portion 58 is perforated by the injection head 38 to supply conditioned fluid into the capsule.

The capsule 6 comprises an axis of rotational symmetry 57 that extends through a centre 59 of the closing member 56 (although not illustrated in the side view of FIG. 7, the capsule 6 has a circular cross-section when viewed in the plane of the closing member 56).

Constructional, manufacturing and/or (beverage) extraction details of containers and/or closing members are for instance disclosed in EP 2155021, EP 2316310, EP 2152608, EP2378932,EP2470053, EP2509473, EP2667757 and EP 2528485.

Referring to FIG. 8, a second example of a container 6 that is for use with the second example of the processing unit 14 comprises the container 6 arranged as a packet and includes: an arrangement of sheet material 62 joined at peripheral seams 64 defining an internal volume for the storage of the precursor material (not illustrated), and; an opening 66, that a user opens to dispense the precursor material into the loose material processing unit 42.

### Arrangement of Code

Referring to FIGS. 7 and 8, the code 44 code is arranged on an exterior surface of the container 6 in any suitable position such that it can be read by the code reading system 18. In the first example shown in FIG. 7, the code 44 is arranged on the closing portion 56. In variant embodiments, which are not illustrated, the code can be arranged on the flange portion 60 (including on either side) and on the containment portion 58. In the second example shown in FIG. 8, the code 44 is arranged at various positions on the sheet material 62, including distal the seams 64.

### Preparation Process

Referring to FIG. 9, the execution of a process for preparing a beverage/foodstuff from precursor material is illustrated:

Block 70: a user supplies a container 6 to the machine 4.

Block 72: the electrical circuitry 16 (e.g. the input unit 50 thereof) receives a user instruction to prepare a beverage/foodstuff from precursor, and the electrical circuitry 16 (e.g. the processor 52) initiates the process.

Block 74: the electrical circuitry 16 controls the processing unit 14 to process the container (e.g. in the first example of the container processing unit 20, the extraction unit 32 is moved from the capsule receiving position (FIG. 4A) to the capsule extraction position (FIG. 4B)).

Block 76: the electrical circuitry 16 controls the code reading system 18 to read the code 44 on the container 6, and provide a digital image of the code.

Block 78: the code processing circuitry of the electrical circuitry 16 processes the digital image to extract the preparation information.

Block 80: the electrical circuitry 16, based on the preparation information, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction portion though the capsule ejection position to eject the container 6 and back to the capsule receiving position.

In variant embodiments, which are not illustrated: the above blocks can be executed in a different order, e.g. block 72 before block 70 or block 76 before block 74; some block can be omitted, e.g. where a machine stores a magazine of capsules block 70 can be omitted; alternatively at blocks 70 to 76 a user presents the code of the container to the code reading system and after it is read opens said container and dispenses the pre-precursor material into the processing unit.

Blocks 76 and 78 may be referred to a code reading and processing process. Block 80 may be referred to as the preparation process. The electrical circuitry 16, includes instructions, e.g. as program code, for the preparation process (or a plurality thereof). In an embodiment the processor 52 implements the instructions stored on a memory (not illustrated).

As part of the preparation process, the electrical circuitry 16 can obtain additional preparation information via the computer network 12 from the server system 8 and/or peripheral device 10 using a communication interface (not illustrated) of the machine.

### Exterior Surface and Code Description

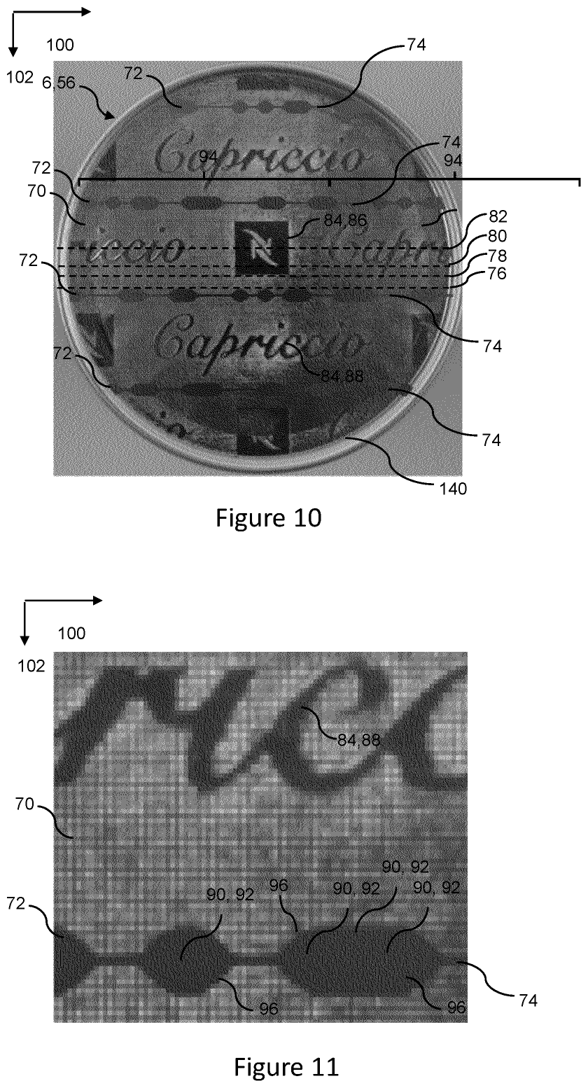

Referring to FIGS. 10 and 11, the entire exterior facing surface of the closing member 56 comprises an exterior surface 70, that includes a code 72 and encoding lines 74 that extend though the code 72.

The image of the exterior surface 70 is circular. In variant embodiments, which are not illustrated: other shapes may be processed including square.

### Exterior Surface and Features

The exterior surface 70 is formed of a first colour range, which in the example, comprises comparatively light colours of an 8-bit greyscale colour system, e.g. decimal numbers 200-255. Other items formed on the exterior surface 70 are formed of a second colour range, which in the example, comprises comparatively dark colours of the 8-bit greyscale colour system, e.g. decimal numbers 0-50.

In variant embodiments, which are not illustrated: other colour systems may be implemented including: 1-bit monochrome; 8-bit colour; 16-bit greyscale, and; 16-bit colour.

The exterior surface 70 has non-encoding lines 76, 78, 80, 82 formed thereon, which may be defined as any line that extends across the exterior surface 70 that is parallel to the encoding lines 74 and the code 72, but does not intersect either of them.

Non-encoding line 76 extends to directly adjoin the code 72. Non-encoding line 78 extends distal the code 72. Both non-encoding lines 76 and 78 are composed entirely of the first colour range.

Non-encoding line 80 extends distal the code 72, and includes an intersected portion of an object 84, which specifical comprises a trademark/logo 86. Non-encoding line 82 extends distal the code 72, and includes an intersected portion of objects 84, which specifically comprise the trademark/logo 86 and text 88 that provides information on the type of beverage produced by the precursor material in the container 6. The objects 84 are composed of the second colour range.

Both non-encoding lines 80 and 82 are therefore composed of a composition of the first colour range and the second colour range. A form and composition of the objects 84 is selected so that non-encoding lines 76, 78, 80, 82 comprise a composition of the second colour range that is identifiably less than that of the encoding line 74, e.g. it may be 20 or 50% less.

In variant embodiments, which are not illustrated: other objects may be formed on the exterior surface, including with different orientations.

Although not explicitly illustrated, it will be appreciated that a corresponding non-encoding lines can be drawn on all portions on the exterior surface 70 that do not comprise the encoding lines 74 and the code 72. Moreover, it will be appreciated that the non-encoding lines are not physically formed on the exterior surface 70, rather they are merely to be considered a idealised virtual line of the exterior surface 70 when processing the image as will be discussed. A thickness of the non-encoding lines 76-82 may be envisaged as that of the encoding line 74, (or with an enlarged thickness when processing for variance as will be discussed) since when an image of the exterior surface 70 is processed it is decomposed into a series of adjoining lines as will be discussed.

### Code and Encoding Line

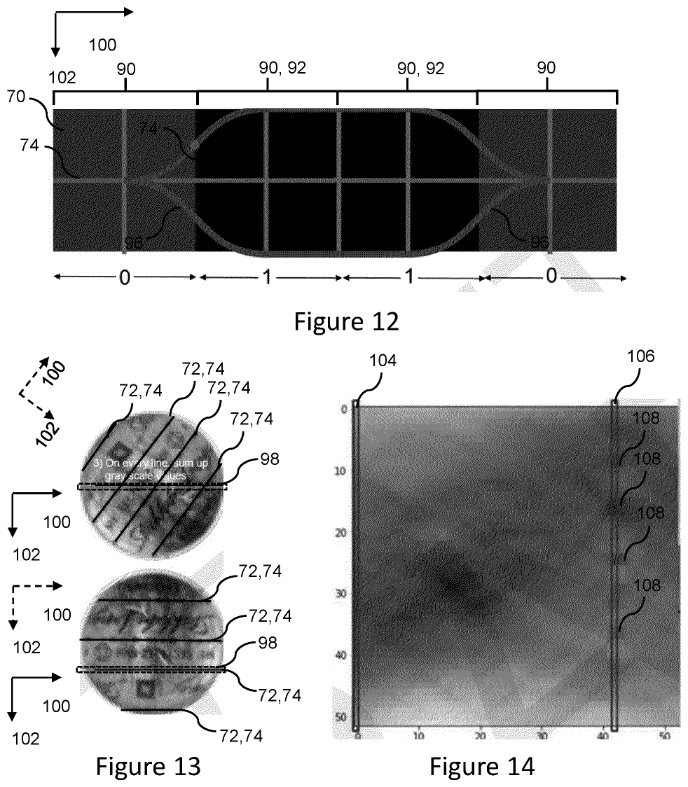

Referring to FIGS. 10-12, the code 72 extends across the exterior surface 70 along the linear encoding line 74 that extends in a longitudinal direction 100. As best seen in FIG. 12, the code 72 comprises a series of discrete positions 90 that either comprise or do not comprise a unit 92. The units 92 and the encoding line 74 are formed of the second colour range. A unit 92 encodes a bit as a 0 or 1 based on its absence or presence in a discrete position 90. The discrete positions 90 are arranged at predetermined intervals apart, i.e. a pitch, along the encoding line 74, which in the example directly adjoin each other, such that they can be predictably located and read.

Referring to FIG. 10, the code 72 is arranged as a repeating unit 94, which sequentially repeats itself in the same order along the encoding line 74. For example, the encoding line 74 may include 1-3 or other number repetitions of the code, any of which can be read to extract the preparation information.

In the example the repeating unit 94 comprises 23 discrete positions 90, hence the code 72 is 23 bits long. The 23 bit long message at least partially encodes the preparation information, for example, it may be used as a key that is associated with a particular set of parameters that define a recipe with a key value database paradigm, which is a stored relationship on an electronic memory of the electrical circuitry 16. Alternatively, the values encode by one or more bits may be directly associated with a value of a parameter, e.g. bits 0-7 encode 1 of 256 magnitudes of a water temperature, which are interpreted and converted to a temperature based a relationship stored on the electronic memory of the electrical circuitry 16.

In variant embodiments, which are not illustrated: the code is repeated only one, and; the code may comprise any number of discrete positions, e.g. 16 or 32.

As can be best seen in FIG. 10, there are multiple encoding lines 74 (four are illustrated) each offset in a lateral direction 102 from and parallel to each other with the same repetitions 94 on the code 72. Therefore any repetition from any encoding line 74 can be read to extract the preparation information. In particular, repetitions 94 on adjacent encoding lines 72 are longitudinally offset by half a code length so that if a region of the exterior surface 70 is damaged there is an increased likelihood of there being an undamaged code repetition 94.

In variant embodiments, which are not illustrated: there may be only a single encoding line, and; the repetitions may have other longitudinal offsets, including a quarter of a code length, or there may be no longitudinal offset.

Referring to FIG. 12, for units 92 of the code 72 that do not adjoin another unit 92, and exterior end region 96 is shaped with a curved end profile such that it symmetrically tapers with increasing longitudinal extent about the encoding line 74 with narrowing lateral thickness to a tip. For units 92 of the code 72 that adjoin on either side other units 92, such that the end regions are not exterior, the shape is square.

As used herein the term “shape” in respect of the units may refer to an exact shape or an approximation of the actual shape, which can occur to a printing or other manufacturing variations in precision.

In variant embodiments, which are not illustrated: the units have a different shape including one or a combination of the following shapes, triangular, polygon, in particular a quadrilateral such as square or parallelogram; other suitable shape.

In embodiments, a thickness in the lateral direction 102 of the encoding line 74 is selected to be comparatively narrow (e.g. less than 20% or 10%) compared to that of a unit 92 of the code 72, it may for example be 0.2 mm for a unit with length 1.1 mm.

The units 92 typically have a unit length of 1.1 mm. As used herein the term “unit length” in respect of a unit 92 may refer to a suitably defined distance of the unit 92, e.g.: for a circular shape the diameter; for a square a side length; for a polygon a distance between opposing or adjacent vertices; for a triangle a hypotenuse. The units 92 maybe arranged with a precision of about 0.05 mm. Since the units are directly 92 adjoining, they have a pitch of 1.1 mm.

The units 92 and the encoding line 74 are formed by printing e.g. by means of an ink printer. As an example of printing the ink may be conventional printer ink and the substrate may be: polyethylene terephthalate (PET); aluminium coated with a lacquer (as found on Nespresso Classic capsules) or other suitable substrate.

In variant embodiments, which are not illustrated: the units are alternatively formed, including by embossing, engraving or other suitable means, and; the units are alternatively dimensioned, e.g. a unit length of 0.5-2 mm.

In a particular variant embodiment, the units and encoding line are formed (e.g. by etching or engraving or by a diffusively reflective paint or other coating on a specular reflector, such as aluminium) to be one of diffusively reflective or specular reflective with the non-encoding lines (or areas not comprising the units of the code or encoding line) to be formed of the other of diffusively reflective or specular reflective. Such an arrangement may be advantageous since in the digital image, specular reflection may appear as a first value range, e.g. light colour tones, and diffusively reflective may appear as a second value range, e.g. dark colour tones, of the colour model. That is, an intensity of the reflection can determine the value of the colour model. However, the visibility of the code may be less apparent than compared to forming the value ranges by printing.

### Colour Tone Summation

Due to physical formation of the encoding line 74, it will be appreciated that: if the exterior surface 70 is split into regions, which are referred to as pixels (as indicated by the grid in FIG. 11, wherein the encoding line 74 is approximately two pixels thick), and; if a greyscale tone (as discussed previously) is assigned to each pixel; then a summation of decimal numbers associated with the tones of said pixels along the length and width the encoding line 74 is identifiable compared to that for an adjacent parallel linear non-encoding lines 76, 78, 80, 82 as shown in FIG. 10 (or any other line) that extends across said exterior surface 70. This is because these non-encoding lines comprise either no or a reduced portion of colour of the second colour range.

The two pixel thick region that extends across between the edges of the exterior surface, and in the example encapsulates the encoding line, is referred to a “section” or a “line section”. And a pixel forming the segment is referred to as an “element” or a “region”.

In particular, since for the encoding line 74 the decimal numbers are all from the second colour range (rather than all or partially including the first colour range as for the non-encoding lines) the summation of the decimal numbers divided by the number of pixels will be much lower than for a non-encoding line. This quantity is referred to the “averaged segment colour tone” or “averaged colour tone”, wherein in this example an element is a pixel and the averaging corresponds to the numbers of elements in the segment. Hence an segment can have a single value of the averaged segment colour tone.

In variant embodiments, which are not illustrated: elements or regions other than single pixels may be considered, for example a single colour tone (i.e. a value) may be assigned to an element that comprises a group of 4, 6 or 9 pixels arranged in squares or rectangles, said elements may comprise a total width that is the same as the width of the encoding line 74.

Referring to FIG. 13 (top image) in embodiments, where the orientation of the code 72 is not initially known (and is show by the dashed local coordinate lines compared to the solid global coordinate lines), the image of the exterior surface 70 is split into longitudinally extending segments 98, which have two pixels in width (as discussed previously). Although only a single segment 98 is show, the segments extend across the entire lateral width of the image. For FIG. 13 (top image) each segment 98 has the averaged segment colour tone calculated.

Then the image is rotated about the axis of symmetry 59 (see FIG. 7, which is at the centre of the circular image) by three degrees and the process of each segment 98 having the averaged segment colour tone calculated is repeated. The process is then repeat until the image has been rotated though 180 degrees.

In variant embodiments, which are not illustrated: the image is rotated by other amounts, including 2 or 4 degrees.

FIG. 14 shows a 2-dimensional contour plot of the averaged segment colour tones for the angle of rotation vs the lateral position of a segment. The angle of rotation in FIG. 13 (top image) corresponds to column 104 in FIG. 14. The angle of rotation in FIG. 13 (bottom image), in which the encoding line 74 is aligned to the longitudinal direction 100, corresponds to column 106 in FIG. 14. Note for column 106, there are a series of localised low regions 108 of averaged segment colour tone. This characteristic feature enables identification of the desired orientation of the code 72.

In variant embodiments, which are not illustrated: the orientation of the code may be known, e.g. by placing the code to extend along a direction identified by an asymmetric structural reference formed on the capsule.

### Determination of Variance

With the code 72 orientated to align to the longitudinal direction 100 as shown in FIG. 13 (bottom image), a preferred encoding line 74 is selected for processing by determining (this time instead of an averaged segment colour tone) for each segment 98 the variance (or standard deviation) of the element colour tones.

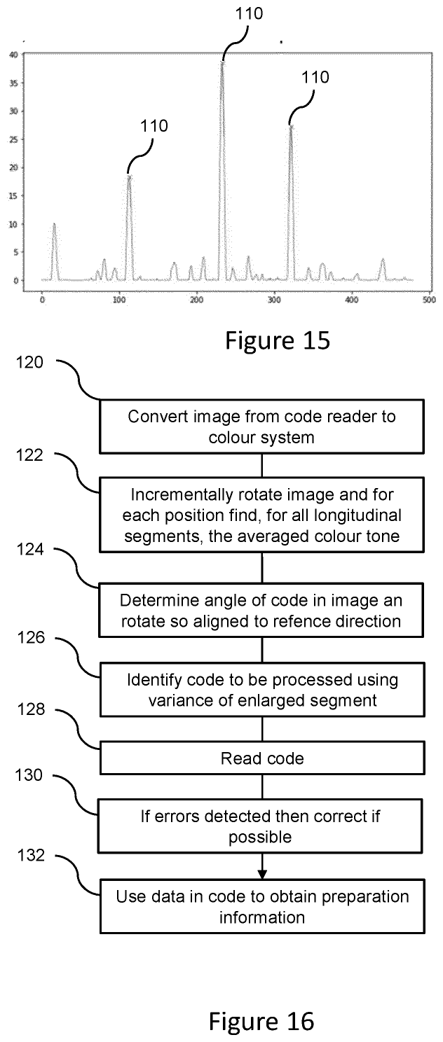

Referring to FIG. 15 the lateral position of a segment 98 vs. the standard deviation for a segment 98 is illustrated. Some optional processing of the raw deviation data has been used, which can include baseline removal and top hat transforms. Since there are four encoding lines 74 in FIG. 13, there are four peaks 110 in the deviation. This is because due to the due to said absence or presence of a unit 92 of the code 72 in the discrete positions 90 on a segment including the encoding line 74 comprises a greater variance of the first colour range and the second colour range than a segment including any of the non-encoding lines 76-82. In particular, because the non-encoding lines 76, 78 in direct proximity of the encoding lines 74 do not comprise any objects 84, they have a comparatively low variance, which enables enhanced locating of the high variance points caused by their adjoining encoding-line 74.

The highest peak 110 corresponds to the longest encoding line 74, which is subsequently selected for processing since, due to its length it has the greatest chance of including one or more complete repetitions of the code 72.

It is to be noted that since the encoding line 74 is a solid line, if this is read directly the variance of will be extremely low, hence a segment thickness when determining variance is increased in lateral thickness to correspond to that of the units 92 of the code 72. Since the encoding line 74 is selected to be comparatively thin compared to the lateral thickness of the units of the code, is does not interfere with the variance. In effect, the averaged colour tones are therefore sampled wat high resolution, and the variance is sampled with at a comparatively low resolution.

To ensure that the code 72 maintains a high variance, restrictions on the encoding pattern can be implemented: it may be required that the code can not be absent or present more than a predetermined number of consecutive units, for example 3 or 4 or 5.

In variant embodiments, which are not illustrated: the variance (or deviation) as discussed above is also used to determine the correct rotation of the code, for example, the correct rotation is determined for a rotary position in which the segment variance produces the highest peaks. In such an embodiment, the encoding line may be omitted.

### Reading of Code and Decoding

With the orientation and location of the encoding line 74 to be read now determined, the units 92 of the discrete positions 90 are read.

In a first example (not illustrated) the code comprises a start sequence of a predetermined, reserved sequence of 0s and 1s. When reading the code the code processing program searches for this reserved sequence of absent and present units. A data sequence is located at a known position (e.g. stored on the memory of the electrical circuitry 16) in respect of the start sequence, for example the data sequence may be the immediately preceding 8-bits. Hence from determining the location of the start sequence the data sequence can then be read to extract the data from the code.

In a second example (not illustrated) a code repetition 94 has a known length, e.g. 23 bits and the units along the encoding line are read and the repeating unit 94 identified based on said numerical repetitions being of said know length. The code processing program implements a Golay decoding decoder to extract the data from the code.

In the event of an error that prevents the data from being extracted: in the first example, e.g. the start sequence can not be located, or in the second example the Golay decoder returns 4-7 bit errors, then the code can be read in the reverse direction, e.g. in FIG. 13 (bottom image), the image is rotated through 180 degrees and the discrete positions 90 are read again.

In the event of a data integrity error: in the first example a parity bit in the data sequence may show and error; or in the second example the Golay decoder returns 0-3 bit errors, then the data may be corrected, e.g. based on matching to a closes known data sequence that is stored on the memory.

The type of errors presented above may also be resolved by selecting a different code repetition from the same encoding line 74 or a different encoding line 74. Moreover, repetitions from two different encoding lines may be stitched together, based on a repetition having a known length.

### Method of Processing Code Image

Referring to FIG. 16, a method of processing the image of the code 72 comprises the following steps (which may be considered an expansion of block 78 in FIG. 9):

Block 120: convert image of exterior surface 70 in to designated colour system (e.g. in the examples this was an 8-bit greyscale).

Block 122: referring to FIGS. 13 and 14, obtain, for each incremented rotation, for segments extending in the longitudinal direction 100, the averaged segment colour tones.

Block 124: determine angle of encoding lines 74 from the averaged segment colour tones based on the highest proportions of the second colour range, and realign local axis of encoding lines 74 to correspond to global longitudinal direction 102 as shown in FIG. 13 (bottom image).

Block 126: Identify encoding line 74 to be processed based on variance of segments.

Block 128: read code repetition from said line.

Block 130: if errors detected then read code in other direction, an/or if a correctable error is detected then correct error in code. If the error can not be corrected then a default set of preparation information may be used in the preparation process.

Block 132: convert data encoded by code to values of parameters of preparation information using rule stored on memory of electrical circuitry 16.

Whilst the code is illustrated herein as being arranged on the container, it will be appreciated that the code can be formed integrally on the container or formed on a separate substrate (not illustrated), which can be attached to the container.

### First Example of Processing Method

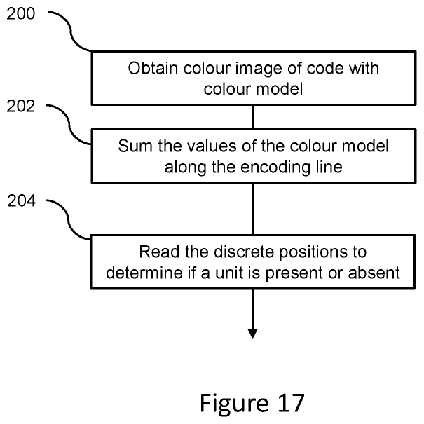

Referring to FIGS. 17, a first example of the method of processing a digital image of the code to extract the preparation information encoded by the code will be described. The first example method which may implement any of the features of the preceding embodiments, including the associated described variants, which for brevity are not described in duplicate.

At block 200 the code reading system 18 obtains a digital image of the code 72 with a colour model applied to the digital image. In the example the colour model is a greyscale colour model.

At block 202 the electrical circuitry 16 sums the values of the colour model along the encoding line, including for the units of the code and the encoding line.

At block 204 the electrical circuitry 16 determines an orientation of the code 44 based on said sum.

At block 206 the electrical circuitry 16 reads the discrete positions 90 to determine if a unit 92 is present or absent based on the determined orientation of the code 72 in said image.

Considering block 200, the values of the greyscale colour model are fitted to regions that comprise a single pixel.

In variant embodiments, which are not illustrated: the regions are downscaled to comprise a grouping of pixels, e.g. 2×2 pixels per region; a different colour model may be implemented.

Referring to FIG. 10, the example digital image comprises an encoding area 140 within which the code 72 and encoding lines 74 are arranged. Since the code 72 is arranged on a circular closing member 56 the digital image comprises the closing member 56 with a rim of the flange portion delineating a circular encoding area 140. As discussed previously, there are multiple encoding lines 74, each having ends at intersection points with the edge of the encoding area 140. Each encoding line can comprise more than one repetition of the code 72. Due to the encoding area being circular, the encoding lines 72 have different lengths.

In variant embodiments, which are not illustrated: there is a single encoding line; each of the one or more encoding lines comprises only a single repetition on the code; the encoding area may have other shapes e.g. square or triangular; the encoding lines may all have the same length, e.g. for a square encoding area; the encoding line may have other shapes, e.g. circular, or square.

At block 204, referring to FIG. 13, top image, the digital image is decomposed into virtual line sections 98, which extend with a length in the longitudinal direction 100 and have a width in the lateral direction 102. The line sections has a width comprising several regions (e.g. 2-6) and a length that corresponds to the length of the encoding area 140. Whilst only a single line section 98 is shown, it will be understood that adjoining parallel line sections are implemented in the lateral direction 102 to decompose the entire encoding area 140. The values of the regions for the line section 98 are summed to provide an array of summed values with one summed value for each line section 98.

The summed value may be averaged by dividing said sum by the number of regions. Averaging in this manner may provide a convenient means for handling line sections with different length (or width). Alternatively, the line sections may be selected to be the same size, thus obviating said averaging. It will be understood that both implementations are based on a sum of the values.

The angle of the digital image is rotated about a central axis (e.g. axis 59 as shown in FIG. 7 which is at the centre of the circular encoding area). A rotational increment of 3 or 5 degrees is applied a total of times 60 or 36 respectively until the digital image has been rotated through 180 degrees. For each rotational position the array of summed values is calculated. A two dimensional plot of summed value vs rotational position is shown for illustrative purposes in FIG. 14. The plot shown in FIG. 14 may be obtained with various filtering/processing techniques, e.g. including a Radon transform with a high pas filter.

Referring to FIG. 14 for the set of array values indicated by column 106 the code 72 and encoding lines 74 are arranged parallel to the longitudinal direction 100, as shown in FIG. 13 bottom image. It can be seen that for column 106 the summed values vary between low values (indicated by the dark regions) and high values (indicated by the light regions).

The low values are provided by the line sections 98 that include the encoding line 74 and code 72. This is due to the influence of the units of the code and the encoding line on the sum of the values. The high values are provided by the line sections 98 that do not include the encoding line 74 and code 72, i.e. the non-encoding lines non-encoding lines 76, 78, 80, 82 as previously discussed. Hence with the code 72 and encoding lines 74 arranged parallel to the longitudinal direction 100, the code is arranged with: a summation of said values of the colour model along the encoding line to be within a first value range, and adjacent non-encoding lines which are parallel to the encoding line to comprise a summation of values of the colour model to be within a second value range.

Accordingly, the standard deviation of the summed values for the array associated with column 106 has the highest deviation value. In this way the orientation of the code 72 based on said sum of values is determined.

In variant embodiments, which are not illustrated: there may be a single encoding line with one or more repetitions of the code. With such an example, a single line section may be implemented to capture an encoding line that extends through a centre of rotation, for example, the line section may be arranged to extend through a centre of the digital image. The condition of the encoding line being aligned to the longitudinal direction may be determined by the rotational position with the summed value that is lowest in magnitude (or highest depending on how the colour model is implemented).

In variant embodiments, which are not illustrated, for the previously discussed same sized line sections, the condition of the encoding line being aligned to the longitudinal direction may be determined by the summed value for a line section at a rotational position crossing a threshold, hence obviating the need for the standard deviation to be calculated.

At block 126, with the orientation of the code 72 and encoding line 74 known the discrete positions 90 can be read along the encoding line 74 in the manner as previously discussed. Any one of the encoding lines may be selected for reading the code, which are identifiable in lateral position by the variance. The code 72 is encoded by Golay encoding, hence an entire encoding line can be read from start to end.

In variant embodiments: other encoding is implemented, e.g. a code with a reserved sequence of bits encoded by the absence or presence of a unit at the discrete position to act as a locator/reference portion which is identified to locate a data portion; the encoding line may be omitted, the orientation of the code may be determined by the influence of the units of the code on the values as discussed with the preceding methods, or the orientation may be determined by a reference portion as disclosed in in WO2017144575A1.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
   4 Machine
      14 Processing unit
         20 Container processing unit (first example)
         32 Extraction unit
         34 Capsule holding portion
         36 Closing member
         38 Injection head
         40 Beverage outlet
         22 Fluid conditioning system
         24 Reservoir
         26 Pump
         28 Heat exchanger
         30 Outlet
         42 Loose material processing unit (second example)
      16 Electrical circuitry
         48 Control electrical circuitry
         50 Input unit
         52 Processor
         54 Feedback system
      18 Code reading system
         46 Image capturing unit
   6 Container
      Capsule—Example 1
      56 Closing portion
         44, 72 Code
         70 Exterior surface
         90 Discrete positions
         92 Unit
         94 Repetition
         74 Encoding line
         76, 78, 80, 82 Non-encoding line
         84 Object
         86 Trademark/logo
         88 Text
      58 Containment portion
      60 Flange portion
      Packet—Example 2
      62 Sheet material
      64 Seams
      68 Opening
   8 Server system
   10 Peripheral device
   12 Computer network
   100 Longitudinal direction
   102 Lateral direction

1. A system comprising a container for containing precursor material and a machine for preparing a beverage and/or foodstuff or a precursor thereof from said precursor material,
the container including:
a machine-readable code storing preparation information,
wherein the code extends along a encoding line, and comprises a series of discrete positions that either comprise or do not comprise a unit to at least partially encode the preparation information,
the machine including:
a code reading system to obtain a digital image of the code and to fit a colour model to the digital image;
a processing unit for processing the precursor material of the container, and;
electrical circuitry to control the processing unit based on the preparation information read from the code and the code reading system,
wherein the electrical circuitry is configured to:
sum values of the colour model along the encoding line, including for the units of the code and the encoding line;
determine an orientation of the code based on said sum, and;
read the discrete positions based on the determined orientation of the code in said image.

2. The system of claim 1, wherein the electrical circuitry is configured to assign the values of the colour model to regions, wherein a region comprises:
an individual pixel of the digital image, or;
a grouping of a plurality of pixels in the digital image.

3. The system of claim 1, wherein the electrical circuitry is configured to sum said values of the colour model for a line section that comprise:
a lateral dimension of one or more regions, and;
a longitudinal dimension of one or more regions to correspond to a longitudinal length that includes an encoding area within which the code is arranged.

4. The system of claim 3 where a lateral dimension of the encoding line is less than a lateral dimension of the line section.

5. The system of claim 3, wherein the electrical circuitry is configured to:
determine said sum for each of a plurality of line sections adjoining each other in the lateral direction.

6. The system of claim 1, wherein the electrical circuitry is configured to:
determine said sum with the encoding line arranged at a plurality of different angles to a a reference axis, and;
based on said sum determine an aligned orientation in which the encoding line is aligned to the reference axis.

7. The system of claim 1, wherein the orientation of the code is determined based on a variance of said sum of values.

8. The system of claim 1, wherein a lateral dimension of the encoding line is selected to be less than 20% or 10% a lateral dimension of a unit of the code.

9. The system of claim 1, wherein the code is arranged as a repeating unit, which repeats itself along the encoding line.

10. The system of claim 1, wherein there are multiple encoding lines, each offset from and parallel to each other.

11. The system of claim 1, wherein the code and encoding line are arranged to be one of diffusively reflective or specular reflective, with a surround surrounding said encoding line and code to be formed as the other of the one of diffusively reflective or specular reflective,
and the electrical circuitry is configured to identify the diffusively reflective and specular reflective regions as values of a colour tone.

12. A machine for preparing a beverage and/or foodstuff or a precursor thereof from a container comprising precursor material and a machine readable code, the machine including:
a code reading system to obtain a digital image of the code and to fit a colour model to the digital image;
a processing unit for processing the precursor material of the container, and;
electrical circuitry to control the processing unit based on the preparation information read from the code and the code reading system,
wherein the code extends along a encoding line, and comprises a series of discrete positions that either comprise or do not comprise a unit to at least partially encode the preparation information,
and the electrical circuitry is configured to:
sum values of the colour model along the encoding line, including for the units of the code and the encoding line;
determine an orientation of the code based on said sum, and;
read the discrete positions based on the determined orientation of the code in said image.

13. A container for containing precursor material, the container including a machine-readable code storing preparation information for processing precursor material,
wherein the code extends along a encoding line, and comprises a series of discrete positions that either comprise or do not comprise a unit to at least partially encode the preparation information,
and a sum of values of colour model fitted to a digital image of the code along the encoding line is identifiable compared to that for an adjacent, parallel non-encoding line, for determination an orientation of the code based on said sum.

14-15. (canceled)
